(19) United States
(12) Patent Application Publication
(10) Pub. No.: US 2006/0058439 A1
(43) Pub. Date: Mar. 16, 2006

(54) Plasticiser-containing PVB film with carboxylic acid esters containing ether bonds as co-plasticizers

(76) Inventor: Uwe Keller, Bonn (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/221,889

(22) Filed: Sep. 9, 2005

(30) Foreign Application Priority Data
Sep. 10, 2004 (DE) 102004043907

(51) Int. Cl. C08K 5/05

(52) U.S. Cl. 524/386; 524/557

(57) ABSTRACT

The invention relates to a plasticizer-containing film based on partially acetalised polyvinyl alcohols containing partially acetalised polyvinyl alcohol, at least one plasticizer with a low polarity and at least one co-plasticizer of the formula R¹—O(—R²—O)ₙ—CO—R⁵ or the formula R¹—O(—R²—O)ₙ—CO—R³—CO—(O—R⁴—)ₘO—R⁶, wherein R¹ to R⁶ are as defined herein. The plasticizer-containing films have a low tendency to exudation and can be used for the production of composite glazings.

### FIELD OF TECHNOLOGY

The invention relates to a plasticizer-containing film based on partially acetalised polyvinyl alcohols, in particular based on polyvinyl butyral (PVB), which film is suitable as intermediate layer in composite safety glass.

### STATE OF THE ART

Composite safety glass generally consists of two panes of glass and an intermediate film bonding the glass panes to each other. Predominantly, plasticizer-containing partially acetalised polyvinyl alcohol, in particular polyvinyl butyral (PVB) is used as film material. Composite safety glass is used for windscreens or side glazing in the motor vehicle sector, for example, and as safety glass in the construction sector.

Meanwhile, aliphatic diesters of triethylene glycol and/,or tetraethylene glycol have become established as plasticizers for such PVC films. Particularly frequently, 3G7, 3G8 or 4G7 are used as plasticizer, the first figure indicating the number of ethylene glycol units and the last figure the number of carbon atoms in the carboxylic acid portion of the compound. Thus, 3G8 stands for triethylene glycol bis-(2-ethylhexanoate), i.e. for a compound with the formula C₄H₉CH(CH₂CH₃)CO(OCH₂CH₂)₃O₂CCH(CH₂CH₃)C₄H₉.

Compounds are preferably used as plasticizer for partially acetalised polyvinyl alcohols which, in a composite safety glass (CSG) intermediate layer film ensure low turbidity, low moisture absorption, good adhesion to the glass and a satisfactory flexibility of the film in the cold. In addition, these compounds must exhibit a satisfactory compatibility with the partially acetalised polyvinyl alcohol, i.e. they must be miscible with the latter in a sufficient quantity without exuding.

In general, the compatibility of plasticizers and partially acetalised polyvinyl alcohol decreases with a decrease in the polar character of the plasticizser. Thus, plasticizers with a higher polarity are more compatible with PVB. Alternatively, the compatibility of plasticizers with a low polarity increases with a decrease in the polyvinyl alcohol content (PVOH), i.e. in the polarity of the PVB resin.

In EP 0877 665 B1, 3G8 with a low polarity is recommended as plasticizer for PVB films because it provides the film product with an improved resistance to moisture. Since moisture can permanently impair the adhesion between the adhesive film and glass and in extreme cases lead to visible detachment of the film from the glass, as high a resistance to moisture of the film as possible is aimed at in the manufacture of composite safety glass (CSG) with PVD film.

The improved resistance to moisture of PVB films plasticised with 3G8 is presumably the result of the stronger non-polar character of this plasticizer in comparison with plasticizers such as 4G7 or 3G7 since, instead of a heptanoic acid radical, an octanoic acid radical constitutes the plasticizer molecule chemically. A further advantage when using 3G8 is its relatively low volatility which, on the one hand; counteracts a depletion of plasticizer on the free edges of the CSG and, on the other hand, results in only a slight inconvenience caused by odour during further processing of the film to CSG.

It has proved to be a disadvantage when using 3G8, however, that this plasticizer is compatible with polyvinyl butyral only to a limited extent precisely because of its low polarity.

In particular, it is not possible to plasticize PVB types exhibiting a polyvinyl alcohol content of more than 19.5% by weight with 3G8 without difficulty since exudation of the plasticizer must then be expected. As in the case of other plasticizer-containing plastic products, the exudation of plasticizer is undesirable also in the case of intermediate films for CSG since a release of plasticizer along the free edge of the PVB at the edge of the composite can lead to premature delamination. As a result of the low compatibility and/or the tendency of 3G8 to exudation, the use of 3G8 in EP 0877 665 B1 is limited to PVB types with a polyvinyl alcohol content of 17-19.5% by weight.

To improve the compatibility of PVB with non-polar plasticizers such as 3G8, WO 02/102591 A1 proposes the use of non-ionic surfactants. These increase the absorption capacity also of PVB with a polyvinyl alcohol content of more than 19.5% by weight for plasticizer with a low polarity and prevent undesirable exudation. Preferably, multiply ethoxylated aliphatic or aromatic alcohols are used as non-ionic surfactants.

To increase the plasticizer absorption capacity of PVB, DE 199 38 159 A1 discloses the use of a plasticizer mixture of a standard plasticizer such as 3G7 and one or several polyalkylene glycols. By using such a plasticizer mixture, the PVB film is capable of absorbing a larger quantity of plasticizer without exudation.

In U.S. Pat. No. 3,644,594 discloses a large number of plasticizers for PVB, including, among others, also glycolic esters of dicarboxylic acids. The use of a certain plasticizer mixture and the improvement in the compatibility between the plasticizer and PVB and/or the exudation behaviour are not described in this case.

In principle, the lack of compatibility of plasticiser/PVB mixtures applies also to other non-polar plasticizers such as, e.g., dialkyl adipates with aliphatic and/or cycloaliphatic ester alcohols, dialkyl sebacates or phthalate plasticizers such as dioctyl phthalate. In the case of a lack of compatibility, an exudation of the plasticizer can be observed also in this case, particularly during storage in a moist and/warm atmosphere.

Thus, it would be desirable to provide plasticizer systems which exhibit a high level of compatibility with partially acetalised polyvinyl alcohols.

### PRESENTATION OF THE INVENTION

Surprisingly enough, it has been found that the exudation of plasticizers with a low polarity from partially acetalised polyvinyl alcohols can be largely prevented by adding co-plasticizers from the group of esters of carboxylic acids with alcohols containing at least one ether bond.

The use of carboxylic acid esters containing at least one ether bond in the alcohol part as plasticizer for PVB is known and disclosed in JP 59-213750 and U.S. Pat. No. 4,452,935. These documents describe the use of these compounds as sole plasticizer of the PVC mixture; the use in mixtures with plasticizers having a low polarity as well as the advantageous effect of suppressing exudation of the plasticizer from the PVB is not described here.

The subject matter of the present invention consequently includes plasticizer-containing films based on partially acetalised polyvinyl alcohols containing
a) 60 to 85% by weight of partially acetalised polyvinyl alcohol,
b) 14 to 35% by weight of at least one plasticizer with a low polarity,
c) 1-20% by weight, preferably 2-10% by weight, of at least one co-plasticizer with the formulae I and/or II
   R¹—O(—R²—O)ₙ—CO—R⁵ (I)
   R¹—O(—R²—O)ₙ—CO—R³—CO—(O—R⁴—)ₘO—R⁶ (II)
   with R¹, R⁵, R⁶: independently of each ether, being H, an aliphatic or aromatic radical with 1 to 12 C atoms,
   R³: a direct bond, divalent aliphatic or aromatic radical with 1 to 12 C atoms
   R², R⁴: independently of each other, a divalent aliphatic or aromatic radical with 1 to 12 C atoms
   n, m: independently of each other, integers of 1 to 10, in particular 1 to 5.

The figures in % by weight relate to the film composition as a whole.

Preferably, R² and R⁴ represent, independently of each other, ethylene radicals, propylene radicals or butylene radicals, i.e. the alcohol functions of the esters are formed by oligomers of ethylene oxide, propylene oxide or butylene oxide.

R¹, R⁵ and R⁶ represent, independently of each other, preferably methyl radicals, ethyl radicals, propyl radicals, butyl radicals or hexyl radicals.

The carboxylic acids of the ester according to formula I are, in particular, benzoic acid, cyclohexane carboxylic acid, acetic acid, propionic acid and carboxylic acids with 4-18 carbon atoms. The following dicarboxylic acids are preferred as carboxylic acid component of the esters according to the formula II: oxalic acid, malonic acid, glutaric acid, succinic acid, adipic acid, pimelic acid, azelaic acid, sebacic acid, terephthalic acid, phthalic acid, isophthalic acid and all stereoisomers of cyclohexane dicarboxylic acid.

The group of suitable additional plasticizers includes for example di-(2-butoxyethyl) adipate (DBEA), di-(2-butoxyethyl) sebacate (DBES), di-(2-butoxyethyl) azelate, di-(2-butoxyethyl) glutarate, di-(2-butoxyethoxyethyl) adipate (DBEEA), di-(2-butoxyethoxyethyl) sebacate (DBEES), di-(2-butoxyethoxyethyl) azelate, di-(2-butoxyethoxyethyl) glutarate, di-(2-hexoxyethyl) adipate, di-(2-hexoxyethyl) sebacate, di-(2-hexoxyethyl) azelate, di-(2-hexoxyethyl) glutarate, di-(2-hexoxyethoxyethyl) adipate, di-(2-hexoxyethoxyethyl) sebacate, di-(2-hexoxyethoxyethyl) azelate, di-(2-hexoxyethoxyethyl) glutarate, di-(2-butoxyethyl) phthalate and/or di-(2-butoxyethoxyethyl) phthalate.

Apart from the plasticizers with a low polarity and the co-plasticizers with the formulae I or II, the films can contain, according to the invention, further additives known to the expert such as residual quantities of water, UV absorbers, antioxidants, adhesion regulators, optical brighteners, stabilisers, colouring agents, processing aids and/or surface active substances.

It is also possible to add plasticizer mixtures of plasticizers with a low and a higher polarity (standard plasticizers). The proportion of standard plasticizers of higher polarity can be between 5-15% by weight, based on the total formulation. Plasticizers of higher polarity are deemed to be plasticizers with a solubility parameter δ of more than/equal to 8.60 (cal/cm³)^{1/2} or 17.59 (J/cm³)^{1/2} such as, e.g., triethylene glycol-di-n-heptanoate (3G7), triethylene glycol-di-2-ethylbutyrate (3GH), triethylene glycol-di-n-hexanoate and dihexyl adipate (DAH).

The greatest advantages from the addition, according to the invention, of the co-plasticizers result when the film according to the invention contains at least one plasticizer with a low polarity in an amount which, without an addition of the co-plasticizers, is incompatible with the partially acetalised polyvinyl alcohol, according to the exudation test described in the following.

Since the co-plasticizers with the formulae I and II possess the properties of plasticizers for partially acetalised polyvinyl alcohols, the plasticizer with a low polarity and the at least one co-plasticizer are preferably used in a total quantity in which the plasticizer with the lower polarity without an addition of the co-plasticizer is incompatible with the partially acetalised polyvinyl alcohol, according to the exudation test.

To assess the plasticizer compatibility and/or to determine whether a plasticizer used in a certain quantity in a certain composition is still compatible or not, a modified standard test, hereinafter called exudation test, is used which is described in EP 0 877 665 B1. As a modification of this test aimed at the quantitative determination of the plasticizer loss of the PVB film, a plasticizer is referred to as being incompatible within the framework of the present invention which has not visibly exuded in droplet form or as a thin film from a plastic film following a specific treatment.

Preferably, a partially butyralated polyvinyl alcohol (polyvinyl butyral) with a hydroxyl group content of more than 19.5% by weight, calculated according to ASTM D 1396 as polyvinyl alcohol (PVOH) also referred to by the abbreviated form of polyvinyl alcohol content or PVOH content in the present application, is used as partially acetalised polyvinyl alcohol since the advantage of the addition, according to the invention, of co-plasticizer can be most advantageously utilised in the case of these resins. Basically, the use of the co-plasticizers improves the compatibility also in the case of PBV compositions, however, whose polyvinyl alcohol content is less than 19.5% be weight. As a rule, the PVOH content of the partially acetalised polyvinyl alcohols used according to the invention is between 13 and 25%.

According to a preferred embodiment of the invention, the alcohol portion of the compounds I and II (i.e. the groups R¹—O(—R²—O)ₙ—; —(O—R⁴—)ₘO—R⁶) consists of a singly or multiply ethoxylated aliphatic alcohol with at least 3 carbon atoms and/or an average degree of ethoxylation of 1 to 10. Multiply ethoxylated aliphatic alcohols with 4 to 20 carbon atoms and/or an average degree of ethoxylation of 1 to 5 are particularly preferred.

Preferably, dialkyl adipates with an alkyl radical with more than 6 carbon atoms and oligoglycolic acid esters with a carboxylic acid radical with more than 7 carbon atoms, in particular triethylene glycol di-2-ethylhexanoate (3G8), dioctyl adipate (DOA), diethylene glycol di-2-ethylhexanoate and/or tetraethylene glycol di-2-hexanoate are used as plasticizers with a low polarity. Consequently, the invention is not restricted to 3G8 but the use of the co-plasticizer can instead also be combined with other plasticizers which, as a result of their apolar character, are incompatible, in the desired quantities, with the PVB resin used.

With reference to polyvinyl butyral, those plasticizers are considered as plasticizers with a low-polarity in this description which exhibit a solubility parameter δ of less than 8.60 (cal/cm³)^{1/2} or 17.59 (J/cm³)^{1/2} at 25° C. For the sake of simplicity, δ can be determined by means of the so-called Small's constant as it is to be found in table form in “Losungsmittel und Weichmachungsmittel” (solvents and plasticizers) (volume 1, 8^{th} edition, page 593, Gnamm/Fuchs, Wissenschaftliche Verlagsgesellschaft mbH Stuttgart 1980). For example, triethylene glycol di-n-heptanoate (3G7) has a δ of 8.71 (cal/cm³)^{1/2} whereas triethylene glycol di-2-ethylhexanoate (3G8) has a δ of 8.51 (cal/cm³)^{1/2}. Dioctyl adipate (DOA) with a solubility parameter of 8.46 (cal/cm³)^{1/2}, diethylene glycol di-2-ethylhexanoate with a solubility parameter of 8.39 (cal/cm³)^{1/2} and tetraethylene glycol di-2-ethylhexanoate with a solubility parameter of 8.49 (cal/cm³)^{1/2} are examples of further preferred apolar plasticizers

Further objects of the invention are the use of one or several compounds with the formulae I or II as a co-plasticizer which increases the compatibility of a plasticizer with a low polarity in partially acetalised polyvinyl alcohol and composite safety glass with at least one glass pane and at least one film according to the invention adjacent to this glass pane.

The films according to the invention can be used in particular for the production of composite safety glass by lamination with one or several glass panes in a manner known to the expert. The composite safety glass can be used in the motor vehicle sector, e.g. as windscreen and also in the construction sector.

In the foregoing and in the following examples, all temperatures are set forth uncorrected in degrees Celsius; and, unless otherwise indicated, all parts and percentages are by weight.

The entire disclosures of all applications, patents and publications, cited above and below, and of corresponding German Application No. 102004043907, filed Sep. 10, 2004 are hereby incorporated by reference.

### EXAMPLES

### Exudation Test

To determine the exudation behaviour of a PVB film, a test strip is placed for 30 days in an atmosphere saturated with water vapour. By absorbing water and as a result of the increase in polarity taking place simultaneously, the plasticizer can be displaced in the case of systems with a low compatibility in such a way that, in the course of time, it is exuded as clearly visible film or in droplet form at the surface of the plastic film. In the case of compatible formulations, no plasticizer exudation can be observed on test strips after 30 days whereas, in the case of incompatible formulations, this is frequently the case after only 24 h. To adjust an atmosphere with a high relative atmospheric humidity (RH), a saturated aqueous solution of copper sulphur pentahydrate with a sediment is produced in a closed vessel, e.g. a glass desiccator. An equilibrium humidity of 98% RH adjusts itself above this solution at 20° C.

To produce plasticised PVB films for testing of their exudation behaviour, the film mass can be homogenised, e.g., on a rolling mill or by extrusion.

All films according to the invention of the examples satisfy the requirements which PVB films for composite safety glass normally have to satisfy, i.e. in detail: a high transparency and/or absence of turbidity, a low inherent colour and, in this case in particular, a low yellow values, a good mechanical strength, a low inherent odour, the possibility of an adhesion reduction when adding the usual anti-adhesion agents, a good and homogeneous adhesion effect on glass.

By way of comparative example 1, it was verified that a PVB resin with a PVOH content of 20.0% by weight and with a typical mixing ratio (74% by weight PBV, 26% by weight 3GH) has partially given off the 3G8 again, i.e. exuded it, in a moist atmosphere after 30 days at the latest.

Comparative example 2 shows that, when using a conventional plasticizer instead of an additional plasticizer according to the invention, no improved compatibility results between PVB resin and 3GH. Examples 4, 5 and 6 prove that, when using a PVB resin with a PVOH content of 20.5% by weight, the formulations according to the invention are resistant to exudation even when stored in an environment with 98% RH and give off neither parts of the plasticizer 3G8 nor parts of the additional plasticiser.

| | Example No. | | | | | |
|---|---|---|---|---|---|---|
| | 1 | 2 | 3 | 4 | 5 | 6 |
| PVB resin | 74 | 74 | 73 | 73 | 73 | 73 |
| PVO content of | 20.2 | 20.2 | 20.5 | 20.5 | 20.5 | 20.5 |
| the PBV resin | | | | | | |
| 3G8 | 26 | 22 | 27 | 22 | 22 | 18 |
| 3G7 | — | 4 | — | — | — | — |
| Palatinol ® K | — | — | — | 5 | | 5 |
| Di(2-butox- | — | — | — | — | 5 | 9 |
| ethyl)adipate | | | | | | |
| Plasticizer | yes | yes | yes | no | no | no |
| exudation after 30 | | | | | | |
| days | | | | | | |

All data are in % by weights based on the composition as a whole, exception: PVO content based on the quantity of the PVB resin.

Palatinol® K=di (2-butoxyethy) phthalate from BASF AG.

All formulations according to the invention exhibit no turbidity in the edge area in which the PBV film is exposed to the humidity without protection in the haze test in which a laminate with the structure of glass-film-glass is stored for 14 days in a climate of 50° C. and 100% relative humidity.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A plasticizer-containing film based on partially acetalised polyvinyl alcohols containing
a) 60 to 85% by weight of partially acetalised polyvinyl alcohol,
b) 14 to 35% by weight of at least one plasticizer with a low polarity,
c) 1-20% by weight of at least one co-plasticizer selected from formulae I and II
R¹—O(—R²—O)ₙ—CO—R⁵ (I)
R¹—O(—R²—O)ₙ—CO—R³—CO—(O—R⁴—)ₘO—R⁶ (II)
wherein
R¹, R⁵, and R⁶ are each, independently of each other, H or an aliphatic or aromatic radical with 1 to 12 C atoms,
R³ is a direct bond or a divalent aliphatic or aromatic radical having up to 12 C atoms,
R² and R⁴ are each, independently of each other, a divalent aliphatic or aromatic radical having up to 12 C atoms, and
n and m are each, independently of each other, an integer of 1 to 10.

2. The film according to claim 1, wherein the plasticizer with a low polarity is used in a quantity which, without an addition of the co-plasticizer, is incompatible, according to the exudation test, with partially acetalised polyvinyl alcohol.

3. The film according to claim 1, wherein the plasticizer with a low polarity and the co-plasticizer are used in a total quantity in which the plasticizer with a low polarity, without an addition of the co-plasticiser, is incompatible, according to the exudation test, with the partially acetalised polyvinyl alcohol.

4. The film according to claim 1, wherein a partially butyralated polyvinyl alcohol (PVB) with a PVOH content of more than 19.5% by weight is used as partially acetalised polyvinyl alcohols.

5. The film according to claim 1, wherein dialkyl adipates with an alkyl radical with more than 6 carbon atoms and oligoglycolic acid ester with a carboxylic acid radical with more than 7 carbon atoms are used as plasticizer with a low polarity.

6. The film according to claim 1, wherein the plasticizer with a low polarity possesses a solubility parameter δ of less than 8.60 (cal/cm³)^{1/2}.

7. The film according to claim 1, wherein the co-plasticizers with the formula II are based on oxalic acid, malonic acid, glutaric acid, succinic acid, adipic acid, pimelic acid, azelaic acid, sebacic acid, terephthalic acid, phthalic acid, isophthalic acid and/or cyclohexane dicarboxylic acid.

8. The film according to claim 1, wherein R² and R⁴ are each, independently, ethylene, propylene or butylene.

9. The film according to claim 1, wherein R¹, R⁵ and R⁶ are each, independently, methyl, ethyl, propyl, butyl or hexyl.

10. The film according to claim 1, wherein said at least one co-plasticizer is selected from formula I and the carboxylic acid used to form the ester according to formula I is selected from benzoic acid, cyclohexane carboxylic acid, acetic acid, propionic acid and carboxylic acids with 4-18 carbon atoms.

11. The film according to claim 1, wherein said at least one co-plasticizer is selected from formula II and the dicarboxylic acid used to form the ester according to formula II is selected from oxalic acid, malonic acid, glutaric acid, succinic acid, adipic acid, pimelic acid, azelaic acid, sebacic acid, terephthalic acid, phthalic acid, isophthalic acid and all stereoisomers of cyclohexane dicarboxylic acid.

12. The film according to claim 1, wherein said at least one co-plasticizer is selected from di-(2-butoxyethyl) adipate (DBEA), di-(2-butoxyethyl) sebacate (DBES), di-(2-butoxyethyl) azelate, di-(2-butoxyethyl) glutarate, di-2-butoxyethoxyethyl) adipate (DBEEA), di-(2-butoxyethoxyethyl) sebacate (DBEES), di-(2-butoxyethoxyethyl) azelate, di-(2-butoxyethoxyethyl) glutarate, di-(2-hexoxyethyl) adipate, di-(2-hexoxyethyl) sebacate, di-(2-hexoxyethyl) azelate, di-(2-hexoxyethyl) glutarate, di-(2-hexoxyethoxyethyl) adipate, di-(2-hexoxyethoxyethyl) sebacate, di-(2-hexoxyethoxyethyl) azelate, di-(2-hexoxyethoxyethyl) glutarate, di-(2-butoxyethyl) phthalate and di-(2-butoxyethoxyethyl) phthalate.

13. The film according to claim 1, wherein said film further contains one or more UV absorbers, antioxidants, adhesion regulators, optical brighteners, stabilisers, colouring agents, processing aids and/or surface active substances.

14. The film according to claim 1, wherein a partially butyralated polyvinyl alcohol (PVB) with a PVOH content of 13-25% by weight is used as partially acetalised polyvinyl alcohols.

15. The film according to claim 1, wherein said at least one plasticizer with a low polarity is selected from triethylene glycol di-2-ethylhexanoate (3G8), dioctyl adipate (DOA), diethylene glycol di-2-ethylhexanoate and tetraethylene glycol di-2-hexanoate

16. A composition comprising:
a) 60 to 85% by weight of partially acetalised polyvinyl alcohol,
b) 14 to 35% by weight of at least one plasticizer with a solubility parameter δ of less than 8.60 (cal/cm³)^{1/2},
c) 1-20% by weight of at least one co-plasticizer selected from formulae I and II
R¹—O(—R²—O)ₙ—CO—R⁵ (I)
R¹—O(—R²—O)ₙ—CO—R³—CO—(O—R⁴—)ₘO—R⁶ (II)
wherein
R¹, R⁵, and R⁶ are each, independently of each other, H or an aliphatic or aromatic radical with 1 to 12 C atoms,
R³ is a direct bond or a divalent aliphatic or aromatic radical having up to 12 C atoms,
R² and R⁴ are each, independently of each other, a divalent aliphatic or aromatic radical having up to 12 C atoms, and
n and m are each, independently of each other, an integer of 1 to 10.

17. The composition according to claim 16, wherein
R² and R⁴ are each, independently, ethylene, propylene or butylenes; and
R¹, R⁵ and R⁶ are each, independently, methyl, ethyl, propyl, butyl or hexyl.

18. A composite safety glass comprising at least one glass pane and at least one film according to claim 1 adjacent to said glass pane.

19. A process for increasing the compatibility of a plasticizer with a low polarity in partially acetalised polyvinyl alcohol, said process comprising combining said plasticizer with low polarity, a partially acetalised polyvinyl alcohol, and one or more co-plasticizer selected from formulae I and II to form a mixture
R¹—O(—R²—O)ₙ—CO—R⁵ (I)
R¹—O(—R²—O)ₙ—CO—R³—CO—(O—R⁴—)ₘO—R⁶ (II)
wherein
R¹, R⁵, and R⁶ are each, independently of each other, H or an aliphatic or aromatic radical with 1 to 12 C atoms,
R³ is a direct bond or a divalent aliphatic or aromatic radical having up to 12 C atoms,
R² and R⁴ are each, independently of each other, a divalent aliphatic or aromatic radical having up to 12 C atoms, and
n and m are each, independently of each other, an integer of 1 to 10.

20. The process according to claim 19, wherein the co-plasticizers are used in a quantity of 1 to 20% by weight based on the total weight of the mixture.
